(19) United States
(12) Patent Application Publication
(10) Pub. No.: US 2016/0147968 A1
(43) Pub. Date: May 26, 2016

(54) HOME-BASED HEALTH AND SKILLS DEVELOPMENT PROGRAMMING SYSTEM

(71) Applicant: Lillie Bruce Coney, Beaumont, TX (US)

(72) Inventor: Lillie Bruce Coney, Beaumont, TX (US)

(21) Appl. No.: 15/012,753

(22) Filed: Feb. 1, 2016

Related U.S. Application Data
(63) Continuation-in-part of application No. 14/648,612, filed on May 29, 2015.
Application No. 14/648,612 is a continuation-in-part of application No. 14/819,360, filed on Aug. 5, 2015.
(60) Provisional application No. 62/110,814, filed on Feb. 2, 2015.
(60) Provisional application No. 61/738,919, filed on Dec. 18, 2012.
(60) Provisional application No. 62/034,088, filed on Aug. 6, 2014.

(51) Int. Cl. G06F 19/00; G06Q 10/10

(52) U.S. Cl. CPC G06F 19/3406; G06F 19/322; G06Q 10/1093

(57) ABSTRACT

Apparatuses, systems and methods associated with a system, comprising a home base device. The home base device may be configured to register a user and receive a user goal. The home base device may further be configured to acquire information relating to the user, wherein the information includes a schedule of planned activities of the user and generate a health plan schedule based on the user goal and the information, wherein the health plan schedule comprises a plurality of health events scheduled to complement the planned activities of the user. The home base device may initiate a reminder for the user to perform one of the plurality of health events in accordance with the health plan schedule.

### RELATED APPLICATIONS

This application: is a non-provisional of, and claims priority to, U.S. Provisional Patent Application No. 62/110,814 filed Feb. 2, 2015; is a continuation-in-part of U.S. patent application Ser. No. 14/648,612 filed May 29, 2015, which is a National Stage Entry of International Application PCT/US2013/075860 filed Dec. 17, 2013, which, in turn, claims priority to U.S. Provisional Patent Application No. 61/738,919 filed Dec. 18, 2012; and is a continuation-in-part of U.S. patent application Ser. No. 14/819,360 filed Aug. 5, 2015, which claims priority to U.S. Provisional Patent Application No. 62/034,088 filed Aug. 6, 2014, all of which are incorporated by reference in their entirety herein.

### COPYRIGHT NOTICE

©2015 Lillie Coney. A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure pertains to a system for health activity management and more specifically to a system for developing and managing an individualized health plan of a user.

### BACKGROUND

Good health is not only a state of being; it is also a state of mind. Good health results from focusing on multiple aspects, including mental health, emotional health, diet and exercise. Maintaining good health may lead to longer, healthier, and more productive lives. However, excelling in these elements of good health is often income dependent, with less income resulting in a compromise of one or more elements of good health.

A lack of good health in society may result in many issues, including fewer people prepared to enter the job market. As an individual's state of health deteriorates, the individual's choices regarding education, skills training, career, lifestyle, career changes, and retirement may be negatively affected. Unfortunately, many unforeseeable events including accidents, disease, and illness may result in deteriorated health, which may shorten career expectations and alter plans of the individual to retire. Therefore, it is even more important to maintain good health when not suffering from unforeseeable events in order to receive greater benefit by making positive choices when healthy and expedite recovery after suffering from accidents, disease, or illness.

A key component causing deteriorating health is the lack of knowledge or the perceived lack of time to dedicate to achieving and maintaining good health. Many individuals working or entering into careers are faced with busy schedules that place great demands on leisure time. Further stress on an individual's time may be created by competing demands produced by family, home life and work life. Due to the high demands on time and lack of resources that may be available to an individual, it has become important to utilize free time in an individual's daily routine to pursue good health practices.

Another contributing factor in good health is recovering from illnesses, disease, accidents, or medical procedures. Patients who have critical care needs due to chronic conditions that require the intervention of advanced wireless or communication enabled health technology to maintain sustainable stable medical condition may benefit from intervention measures to manage recovery and avoid unnecessary hospital readmissions. Such patients include those who depend on, but are not limited to, assistive medical devices such as pacemakers, insulin pumps, respiration support, or who are recovering from accidents, surgery or injury.

### SUMMARY

The following is a summary of the present disclosure in order to provide a basic understanding of some aspects of the disclosed subject matter. The summary is not intended to identify key/critical elements of the disclosed subject matter or delineate the scope of the disclosed subject matter. Its sole purpose is to present some concepts of the disclosed subject matter in a simplified form as a prelude to the more detailed description that is presented later.

Systems and methods for encouraging safe, reliable, patient-centered and person-centered health maintenance are disclosed. A Home-Based Health Skills Development Programming System (HBHSD) may receive information relating to an individual and generate a health plan and/or a health recovery plan for achieving and maintaining a level of health based on the received information. The health plan may include one or more programs that could range from workout routines to medical recovery plans provided by healthcare professionals. Further, the HBHSD may support data collected from disparate medical device communication interfaces from a range of critical care assistive medical devices to convey data to manufacturers, healthcare professionals and patients regarding environment and physical condition. Notifications may be sent to the individual regarding the performing of events associated with the health plan.

The HBHSD may register the individual as a user of the system and receive a health goal defined by a healthcare professional, a hospital, or the user. Once registered, the HBHSD may acquire information relating to the user from either or both of information input by the user or a plurality of devices, which can included critical healthcare technology such as insulin pumps, pacemakers, co-ocular implants, or systems networked with the HBHSD. The information acquired may include a schedule of the user's planned activities for a time period. Based on the user's goal and the schedule of the user's planned activities, the HBHSD may generate a workout plan schedule comprising a plurality of workout events scheduled during free times in the schedule of the user's planned activities. The HBHSD may generate notices informing the user of the workout events and providing direction of how to perform the workout events.

In some examples, the HBHSD in conjunction with other technology may collect and transmit data on self-directed therapy in support of trained therapy instruction.

In some examples, the HBHSD may be designed to work solely with critical care healthcare technology as a data collection and transmission system for manufacturers, hospitals, physicians or individuals to monitor and manage health while living with chronic conditions. The HBHSD can accept a set course of directives from medical professionals or hospitals regarding recovery plans and benchmarks that are individualized for a patient.

In some examples, the HBHSD may schedule nutrition events based on the user's goal and the schedule of the user's planned activities. The nutrition events may indicate a time when a user should eat or drink and indicate what should be ingested by the user. The HBHSD may generate notices informing the user of the nutrition events and provide recipes for preparing the food or drink associated with the nutrition events.

In some examples, the HBHSD may generate and/or initiate directives for the scheduling of therapy sessions, consultations, nutrition or other goals that support desired outcomes based on the medical care provider's recovery plan, user's goal and/or the schedule of the user's planned activities.

The medication, nutrition and/or treatment events may indicate a time when a user should take medication, engage in personal therapy support, eat or drink and indicate what should be ingested by the user based on health and environmental conditions and/or other factors. The HBHSD may generate notices informing the user of the nutrition events and may, in some examples, provide recipes for preparing the food or drink associated with the nutrition events.

The HBHSD may act as the trusted agent to manage secure and private communication generated by medical devices among the admitting hospital, medical professionals, medical support team, patient and caregivers to maximize critical early intervention should medical condition of patients indicate it is desirable.

The home base device may further be configured to acquire information relating to the user, wherein the information includes a schedule of planned activities of the user and generate a health plan schedule based on the user goal and the information, receive programing from a discharging hospital on patient recovery plan, accept communication from manufacturer once authenticated to allow communication with manufacturer regarding their technology wherein the health plan schedule comprises a plurality of health events scheduled to complement the planned activities of the user. The home base device may initiate a reminder for the user to perform one of the plurality of health events in accordance with the health plan schedule. The device may support programs, plans or technologies to assist in the reduction of hospital readmissions, promote privacy, security, health and wellbeing of patients with critical care technology.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an example network comprising a home based health and skills development programming system (HBHSD).

FIG. 2 illustrates an example HBHSD communicatively coupled to network systems.

FIG. 3 illustrates an example network comprising an HBHSD communicatively coupled to various care-related service providers.

FIG. 4 illustrates an example process of an HBHSD implementing a workout plan.

FIG. 5 illustrates an example process of an HBHSD modifying a workout plan based on non-completed workout events.

FIG. 6 illustrates an example schedule acquired by an HBHSD.

FIG. 7 illustrates an example process of an HBHSD modifying a workout plan based on acquired data.

FIG. 8 illustrates an example implementation device preparation network with geo-proximity coral determining presence of a token.

FIG. 9 illustrates an example process of an HBHSD implementing a nutrition plan.

FIG. 10 illustrates an example network between a HBHSD and a central programming device.

### DETAILED DESCRIPTION

A Home-Based Health and Skills Development Programming System (HBHSD) designed to encourage safe, reliable and person-centered health maintenance, and improve or hone activities, existing skills, or new skills development, while protecting the privacy of a user is herein disclosed.

The HBHSD may further be designed to support a reduction in hospital readmissions while maintaining high quality healthcare and recovery post discharge. The HBHSD may still further be designed to support communication from multiple critical care proprietary devices provided by healthcare manufacturers geared toward the recovery and/or health status maintenance for ill patients recovering from hospital stays.

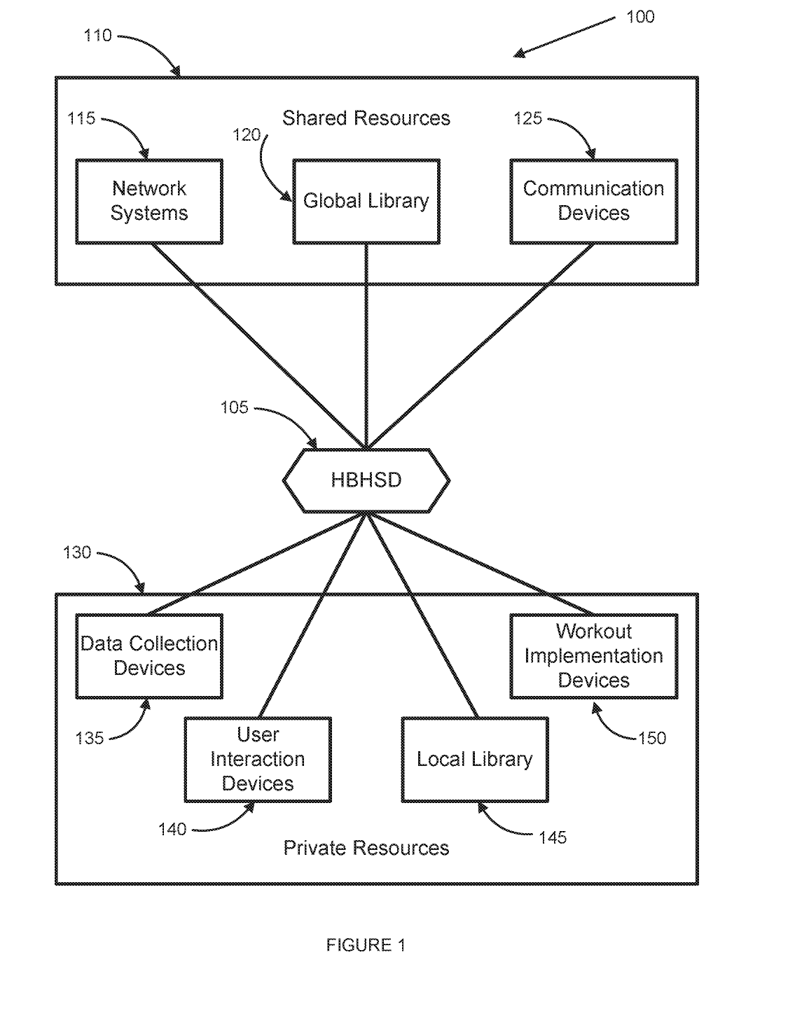

FIG. 1 illustrates an example network 100 comprising a HBHSD 105. HBHSD 105 may be communicatively coupled to one or both of shared resources 110, configured to be accessible by a community including a plurality of HBHSDs or the general public, and private resources 130, configured to be accessible by identified users associated with the private resources.

The private resources 130 may comprise one or more communicatively coupled devices or components that may be configured to communicate information to, or receive and store information from, the HBHSD 105. The private resources 130 may be configured to limit access of the communicated or stored information to one or more identified users or to a user associated with the information.

The private resources 130 may include user interaction devices 140, which are configured to allow a user to interact with the HBHSD 105. The user interaction devices 140 may comprise one or more keyboards, mice, touch screens, keypads, or any other device that a user may utilize to input information. Communication between the HBHSD 105 and the user interaction devices 140 may be secured, allowing only the user access to the communication.

The critical health data and/or patient discharge recovery plan and related data may be communicated to hospitals, physicians, healthcare providers, manufacturers and/or patients in near real time to facilitate interventions prior to critical care events. The HBHSD can support the coalescence and analysis of data to support hospitals, physicians, emergency management technicians, care givers and/or patients in understanding a patient's medical state.

The private resources 130 may further comprise data collection devices 135. The data collection devices 135 may be configured to collect data related to the user while maintaining confidentiality of the data. The data collection devices 135 may be configured to track daily physical activities and provide the tracked data to the HBHSD for comparison to previous states of the user and progress to the user's goal. The data collection devices 135 may be configured to allow an authorized user to suspend the collection of data and restart the collection of data when desired.

The data collection devices 135 may comprise one or more sensors that measure vitals of a user, bio-generated data, and/or environmental conditions. In some examples, the data collection devices 135 may include computing devices that have relevant information stored thereon, such as information related to the user and/or to generating the health plan. Information collected by the data collection devices 135 may be stored and/or analyzed to develop or modify a health plan for a user.

The data collection devices 135 may include a range of IP-enabled wireless digital devices that may include, but are not limited to, pacemakers, insulin pumps, co-ocular implants, bio-implants, bio-sensory technology that measure physical or emotional state, high resolution digital or other optical sensory data, scales, smart measuring devices, body mass measuring instruments and/or millimeter wave devices, or other technology, that can accurately measure and calculate body mass data, and support physiology analytic processes. Further, the data collection devices 135 may include thermal and other imaging systems for measuring data associated with the user.

The data collection devices 135 may comprise clothing sensors or proximity sensors incorporated into clothing, and/or sensors applied to a user's skin, similar to the methods used in hospitals for medical reading from heart monitors. The clothing and/or proximity sensors may be incorporated into skin adhering body wears. Further, the clothing and/or proximity sensors may comprise bio-chemical sensors that may sense environmental conditions, hydration levels, endurance levels and a physical condition of a user. The data collection devices may also comprise one or more heart monitors, blood pressure monitors, and/or body temperature monitors.

In some examples, the data collection devices 135 may comprise wearable sensors providing one-way or two-way audio, visual and/or sensory communication among the HBHSD 105 and the data collection devices 135. For example, the data collection devices 135 may be configured to communicate information about correcting posture or position of limbs. In some examples, the data collection devices 135 may communicate the information during therapy sessions and/or physical activity. The data collection devices 135 may provide non-verbal sensory feedback, such as providing a sensation of a person applying a hand to the right shoulder.

In some examples, the data collection devices 135 may be activity-specific collection devices. For example, a user may perform a physical activity such as golfing, where a golf club and golf ball associated with the activity may contain sensors. In some examples, the physical activity may be part of a therapy plan of the user. The sensors may comprise nanotechnology sensors, wireless sensors, or any other sensors to sense variables associated with the physical activity. The sensors may be built into and/or installed in materials worn or imbedded in the environment. In some examples, the sensors may be incorporated additionally, or alternatively, into the golf club and/or the golf ball. In the golf example, the data collection devices 135 may measure height, range, accuracy, point where the club made contact with the ball, other conditions relevant to skills training, or any combination thereof.

In examples where a user is performing skills training, the data collection devices 135 may be configured to record each attempt at performing the skill. The HBHSD 105 may compare the recorded data with previous attempts and adjust instructions for the skills training to aid in improvement based on the recorded data. Further, the HBHSD 105 may compensate for differences between a patient recovery and/or training model and the user in determining optimal performance based on the data provided by the data collection devices 135. For example, the HBHSD 105 may factor in a training model's attributes, such as being a professional golfer, height, weight, strength and force that can be put into a swing when compared with an attempt by the user in completing the activity to determine optimal performance. Training model's skill levels may vary from beginner to expert, and additional training models may be added based on recorded data from users of HBHSDs, such as HBHSD 105.

In some examples, the HBHSD 105 may allow a user to generate workout activities, skills activities, nutrition activities, or any combination thereof, that may be utilized by the HBHSD 105 in a health plan. The activities may aid in improvement of defined skills or activities the user identifies. Further, the user may program the HBHSD 105 to link to apparel or goods used during the activity, therefore allowing the HBHSD 105 to receive information from the apparel and/or goods, or to transmit information and/or instructions to the apparel or goods.

Access to data gathered by the data collection devices 135 may be controlled by the user. The data may be used to benchmark progress of the user in an associated health plan. In some examples, the user may choose to share the data with a trained instructor, whom may provide guidance and advice to the user.

The private resources 130 may further comprise a local library 145. Local library 145 may store instructions for performing events within a health plan, may store videos showing how to perform an activity, or may store data collected from the data collection devices 135 and the user interaction devices 140, the data including audio and visual recordings generated by the HBHSD 105.

The private resources 130 may further comprise workout implementation devices 150. The workout implementation devices 150 may include workout machines communicatively coupled to the HBHSD 105. The HBHSD 105 may be configured to transmit exercise programs to the workout implementation devices 150 and, in response to the transmission, the workout implementation devices 150 may be configured to turn on and load settings for a workout event to be performed by a user.

Data stored, acquired, or produced by the private resources 130 and the HBHSD 105 may be strongly encrypted to protect the data during storage, access, transmission and use. The private resources 130 and the HBHSD 105 may be configured to limit access, editing, erasing and discarding of data to an authorized user. Data stored on the private resources 130 and the HBHSD 105 related to a user may be permanently erased from the private resources 130 and the HBHSD 105, thereby allowing for resale of the HBHSD 105.

The shared resources 110 may comprise network systems 115. Network systems 115 may comprise servers including globally accessible information, such as websites with information about public transportation and schedules, weather forecasts, traffic reporting systems, and telecommunication systems. The HBHSD 105 may be configured to identify useful information stored on the network systems 115 and utilize the useful information to generate or modify a health plan. The useful information may be utilized to generate a health plan that maximizes a benefit to a user of the system in view of the useful information. For example, information regarding weather conditions or traffic conditions may indicate a change in the health plan will produce greater benefits to the user.

The shared resources 110 may further comprise one or more global libraries 120. The global libraries 120 may be configured to store information from, and transmit information to a plurality of HBHSDs, including HBHSD 105. For example, the global libraries 120 may include instructions and videos for health activities to be performed by a prospective user. Further, the global libraries 120 may be configured to receive data from one HBHSD and share the data to a plurality of HBHSDs. For example, a user may generate an instruction video and choose to share it with a plurality of other users by uploading the video to the global libraries 120 for later download by other users.

The shared resources 110 may further comprise communication devices 125. The communication devices 125 may be configured to communicate with other, publicly available devices and resources to gather information. Communication devices 125 may comprise cell phones, laptops, desktops, tablets, handheld devices, or any other device that may be configured to communicate with other devices or resources.

The communication devices 125 may be used to communicate information between the HBHSD 105 and a user. For example, the HBHSD 105 may transmit a user's accomplishments, such as calories discarded on a day. Further, the communication devices 125 may allow a user to access information from the HBHSD, such as alternative nutrition options or workout options to help plan ahead for special events that may cause deviation from a health plan.

In some examples, one or more of the shared resources 110 and/or the private resources 130 may be configured to store or access entertainment files, such as audio books, music, work related information, lectures or other file types that a user may want to access or play during a workout event. The HBHSD 105 may be configured to display the entertainment files or may transmit the entertainment files for display on one or more of the communication devices 125, the user interaction devices 140, and the workout implementation devices 150.

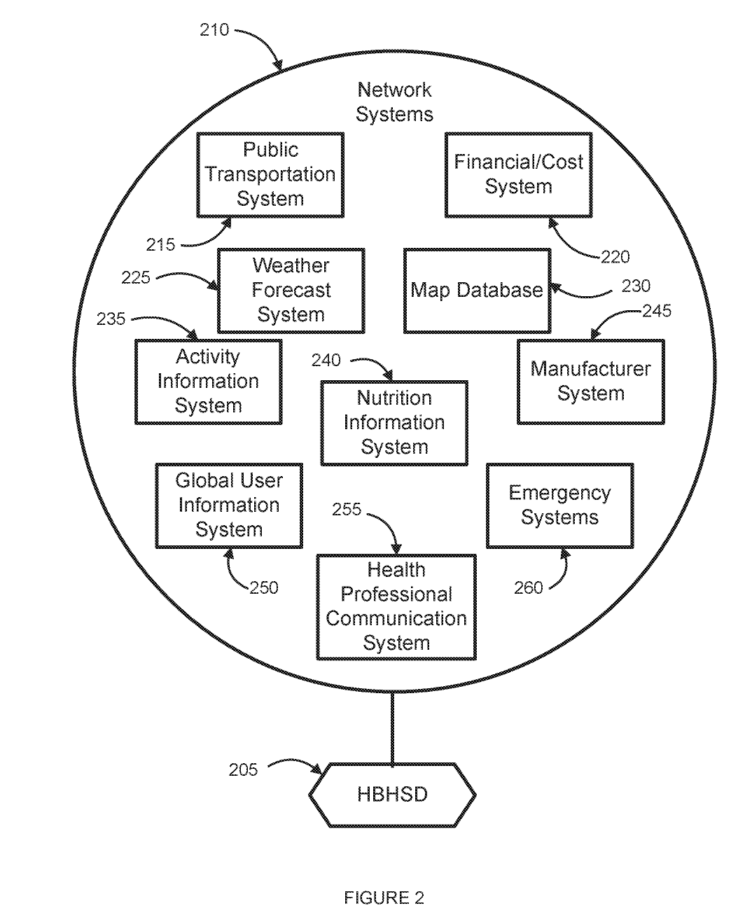

FIG. 2 illustrates an example HBHSD 205 communicatively coupled to network systems 210. Network systems 210 may comprise one or more systems relating to one or more different topics. The HBHSD 205 may include one or more of the features of HBHSD 105 (FIG. 1).

Network systems 210 may include systems containing publically-accessible information related to resources that are available to a user, such as public transportation system 215, financial/cost system 220, weather forecast system 225, and map database 230. Communication with the public transportation system 215, the financial/cost system 220, the weather forecast system 225, and the map database 230 may be configured for one-way data collection, thereby the HBHSD 205 collecting data from the network systems 210 without transmitting personal information from the HBHSD 205.

Based on information gathered from the systems, the HBHSD 205 may generate or adjust a health plan associated with a user. For example, a bus running 10 minutes late may allow for an extra walk before the bus arrives at the bus stop. As a further example, if traffic will delay arrival by 30 minutes, the HBHSD 205 may recommend a 30 minute delay before leaving home and may recommend an addition to a health plan to utilize the additional time, such as going for a 30 minute run.

Information obtained from the financial/cost system 220 may be utilized by the HBHSD 205 to generate a notice of a benefit. For example, the HBHSD 205 may recommend a switch from canned soda to water and may provide a notice stating how much money is saved by the switch as an inducement. Further, the HBHSD 205 may provide a notice of an opportunity cost of forgoing use of a gym or purchase of exercise equipment. The notice may also provide corresponding alterations to a health plan that may occur from forgoing use of the gym or purchase of exercise equipment, such as that results or goals/milestones may be impacted.

The map database 230 may be able to identify a current location of a user associated with the HBHSD 205. The map database 230 may include a library of facilities, such as gyms and parks, which can be utilized by the user associated with the HBHSD 205 and may include information about the facilities, such as times of operation. The HBHSD 205 may be configured to identify facilities near a current location of the user and provide walking and/or driving directions to one or more of the facilities.

Network systems 210 may further comprise activity information system 235 and/or nutrition information system 240. The activity information system 235 may include instructions of how to perform a certain exercise or activity. The instructions may include one or more types of instructions, including audio recordings, visual representations, and/or video instructions. The instructions may include multiple language formats and may include translation services. The activity information system 235 may further include information on type of items needed for an activity, a recommended physical design of the activity, a type of surface recommended for the activity, length of time each activity should be performed, and similar information on how to perform an activity.

The activity information system 235 may further include pre-recorded exercise classes and/or demonstrations associated with an activity in a health plan. The pre-recorded exercise classes and/or demonstrations may include recordings generated by appropriate experts at the skill and level of technique desired. Further, the activity information system 235 may include data gathered by sensors as the expert is performing the activity shown in a recording. For example, the data gathered by a golfing expert may include the expert's height, weight, strength, stance, posture data, type and weight of clubs used, force exerted by the swing, and data concerning contact with the ball.

The nutrition information system 240 may include information about different nutritional and/or dietary events utilized in a health plan. The nutrition information system may comprise a library of recipes and may be configured to support addition of new recipes.

In some examples, nutrition information system 240 may be configured to access information regarding availability of nutrition items, including foods and liquids, available at local markets. Accessing the information may comprise accessing a database of nutrition items maintained by a local market and identifying the nutrition items in the database. The nutrition information system 240 may further be configured to access or acquire nutrition information associated with the available nutrition items. In generating a health plan, the HBHSD 205 may take into consideration the available nutrition items and associated nutrition information when selecting nutrition events for a user.

The nutrition information system 240 may additionally include information concerning substitutions that may be made to nutrition in a health plan. For example, the HBHSD 205 may be able to identify alternatives for nutrition based on what foods are available. Further, the HBHSD 205 may be able to modify nutrition in a health plan based on consumption of substitute nutrition, such as eating a piece of cake rather than an apple which was scheduled. The HBHSD 205 may be configured to modify nutrition in a health plan based on food at a given event prior to the given event occurring, thereby being able to compensate for the substitutions to the health plan that will occur in the future.

The activity information system 235 and the nutrition information system 240 may further store words of encouragement, support, instructions, and hints at ways to improve results, anecdotes and more to make the training enjoyable and less stressful. These stored items may be paired with activities as a way to motivate a user to complete the activity. The source and types of voices may expand as the system evolves to include personalized messages from the user to themselves or the voices of others or synthetic voice renderings.

Network systems 210 may further comprise manufacturer systems 245. The manufacturer systems 245 may be configured to allow manufacturers to receive status and updates related to the functioning of the HBHSD 205 or the functionality as it relates to user's full use of the device features. Further, the manufacturer systems 245 may support installation of updates and may communicate with users regarding product warranties, uses, and upgrades or improvements that may be made to the HBHSD 205.

Network systems 210 may further comprise global user information systems 250. The global user information systems 250 may store information related to one or more users of the HBHSD 205 that may be accessed by users of other HBHSDs, manufacturers, the general public, or any combination thereof. Further the global user information systems 250 may store audio, visual representation, video, or other types of data generated by a user that may be shared with users of other HBHSDs.

Network systems 210 may further comprise health professional communication systems 255. The health professional communication systems 255 may be configured to provide two-way communication among the HBHSD 205 and a health professional. The two-way communication may comprise either, or both, of audio and visual communication mediums. Therefore, the physician may be able to provide detailed instructions to a user of the HBHSD using both audio and visual communication.

Further, the HBHSD 205 may be configured to transmit and receive information from the health professional communication systems 255. For example, videos and/or other data gathered corresponding to a user may be transmitted to the health professional communication systems 255 for analysis by a physician. In response, instructions concerning a health plan associated with the user may be transmitted from the health professional communication systems 255 to the HBHSD 205.

Network systems 210 may further comprise emergency systems 260. Emergency systems 260 may comprise home security systems or other communication means established by the user should a medical crisis arise requiring medical intervention. In response to sensing a medical emergency, condition, or irregularity, the HBHSD 205 may transmit a communication to the emergency systems 260 requesting service.

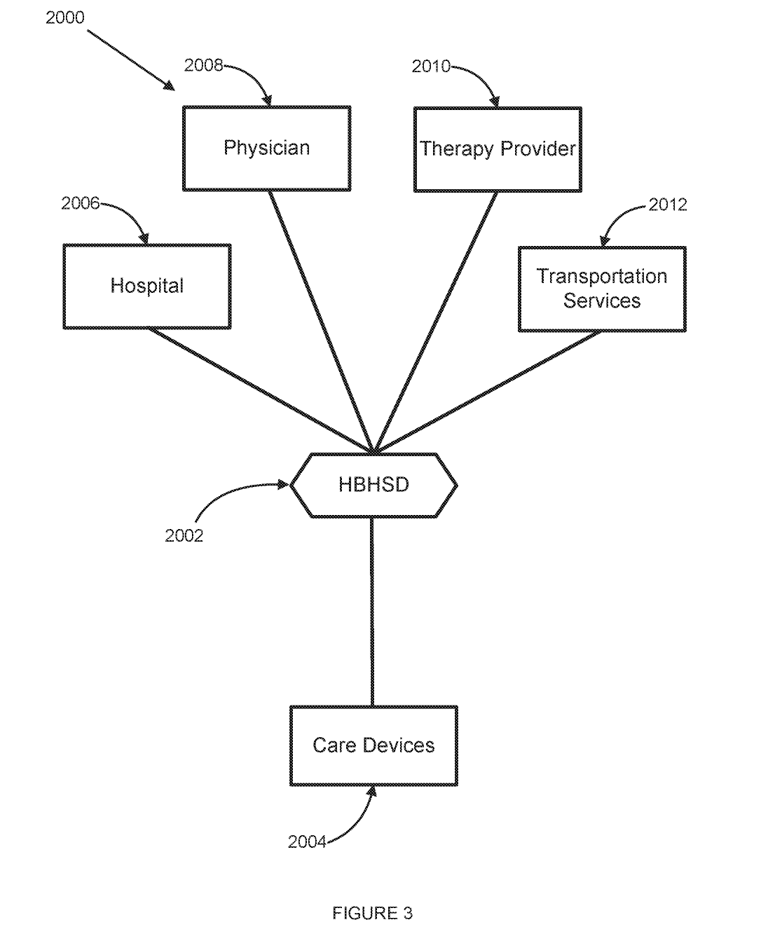

FIG. 3 illustrates an example network 2000 comprising an HBHSD 2002 communicatively coupled to various care-related service providers. The HBHSD 2002 may include one or more of the features of the HBHSD 105 (FIG. 1) and/or the HBHSD 205 (FIG. 2)

The HBHSD 2002 may further be communicatively coupled to one or more care devices 2004. The care devices 2004 may include critical care devices provided or manufactured by one or more of the care-related service providers. The care devices 2004 may be issued to a user of the HBHSD 2002 and/or may be issued with the HBHSD 2002 by one or more of the care-related service providers.

The care devices 2004 may include insulin pumps, pace makers, co-ocular implants, bio-implants, bio-sensory technology that measure physical or emotional state, high resolution digital or other optical sensory data, scales, smart measuring devices, body mass measuring instruments and/or millimeter wave devices, similar devices, or some combination thereof. The care devices 2004 may receive, measure, sense and/or record data associated with the user and/or environmental conditions proximate to the user and/or the care devices 2004. The care devices 2004 may store the data and/or may transmit the data to the HBHSD 2002 for storage.

The care-related service providers may include hospitals 2006, physician 2008, therapy providers 2010, physicians, home-health care providers, similar service providers, or some combination thereof. The care-related service providers may receive data from the HBHSD 2002 and analyze the data. The data may be transmitted to the care-related service providers at set time intervals, adjustable time intervals, upon the occurrence of some event, or some combination thereof. The time intervals and/or the events for transmission of the data may be defined by one or more of the care-related service providers, the user of the HBHSD 2002, or some combination thereof. The data transmitted to the care-related service providers may be manually or automatically entered into a medical record of the user of the HBHSD 2002, allowing for full analysis of the medical record to improve post discharge protocols for the user and/or to reduce the likelihood of readmission of the user.

Communication by the HBHSD 2002 with the care-related service providers maybe provided as a dedicated service. The network 2000 may be utilized for support in the recovery of patients, some of which may be critical care patients, who are discharged from hospitals. The network 2000 may help in the reduction of hospital readmission. The network 2000 may support the goal of improving health outcomes and provides recovery options that improve the quality of life and sustainability with the greatest level of independence, privacy and security of the patient, while allowing the patient to collaboratively work with home care givers, family members, physicians, discharging hospitals, device (HBHSD 2002 and/or care devices 2004) manufacturers, or some combination thereof.

Based on the analysis of the data, the care-related service providers may transmit a health plan, a workout plan, a recovery plan, a nutrition plan, instructions to modify any plans already residing on the HBHSD 2002, or some combination to the HBHSD 2002. In response to receiving the transmission from the care-related service providers, the HBHSD 2002 may implement the received plan and/or modify the existing plan in accordance with the transmission. The plans provided by the care-related service providers may be based on trends identified based on data collected across a plurality of HBHSD devices, or through other sources, and may allow the care-related service providers to intervene where appropriate.

In some examples, the care-related service providers may include a manufacturer of the HBHSD 2002, the care devices 2004, or some combination thereof. The manufacturer may receive transmissions from the HBHSD 2002 that indicates that the HBHSD 2002 and/or one or more of the care devices 2004 is malfunctioning, allowing the manufacturer to rectify the malfunction. Transmissions between the care devices 2004 and the HBHSD 2002, between the other care-related service providers, and/or the data stored on the HBHSD 2002 may be encrypted, or some other protected from access by the manufacturer, such that the manufacturer cannot access sensitive and/or confidential information associated with the user of the HBHSD 2002.

The HBHSD 2002 may issue an alert to one or more of the care-related service providers based on data received by the HBHSD 2002. The data received by the HBHSD 2002 may indicate that the user of the HBHSD 2002 is experiencing a medical emergency and the HBHSD 2002 may transmit the alert to the care-related service providers indicating the medical emergency, thereby allowing the care-related service providers to take emergency actions such as readmission of the user. The alert may be transmitted in response to detecting that the medical emergency is being experienced and may be independent of any other scheduling of data transmission to the care-related service providers.

In some examples, the alert may further be transmitted to a transportation service 2012. The alert may indicate that the user of the HBHSD 2002 requires transportation to one of the care-related service providers. The alert may include a location of the user (obtained based on a location of the HBHSD 2002, the care devices 2004, or some combination thereof), a location of the care-related service provider to which the user requires transportation, or some combination thereof. The transportation service 2012 may include an ambulance provider, a medical care transportation provider, some other transportation provider, or some combination thereof. In some examples, the specific transportation service 2012 to which the alert is transmitted by determined by the type and/or severity of the emergency and may be defined and/or assigned by the care-related service providers.

In some examples, one or more of the care-related service providers may be able to control and/or changes settings of the HBHSD 2002, the care devices 2004, or some combination thereof. The care-related service providers may be able to control what data is transmitted by the HBHSD 2002 and/or the care devices 2004, the frequency at which the data is transmitted, what data is collected by the HBHSD 2002 and/or the care devices 2004, the sharing of the data, the plans (health, workout, recovery, and/or nutrition) associated with a user of the HBHSD 2002, or some combination thereof. The care-related service providers may further be able to limit the changes to the settings of the HBHSD 2002 and/or the care devices 2004 that a user of the HBHSD 2002 through the control. The care-related service providers may transmit a request to the HBHSD 2002 requesting control of and/or changes to the settings of the HBHSD 2002 and/or care devices 2004.

In some embodiments, the data of the HBHSD 2002, the data of the care devices 2004, the data communicated among the HBHSD 2002, the care devices 2004 and/or the care-related service providers, or some combination may have limited access. The data may be encrypted, or other means of limiting access, providing protection against access by unauthorized users. Access may be limited to the care-related service providers, a portion of the care-related service providers, the user of the HBHSD 2002, or some combination thereof.

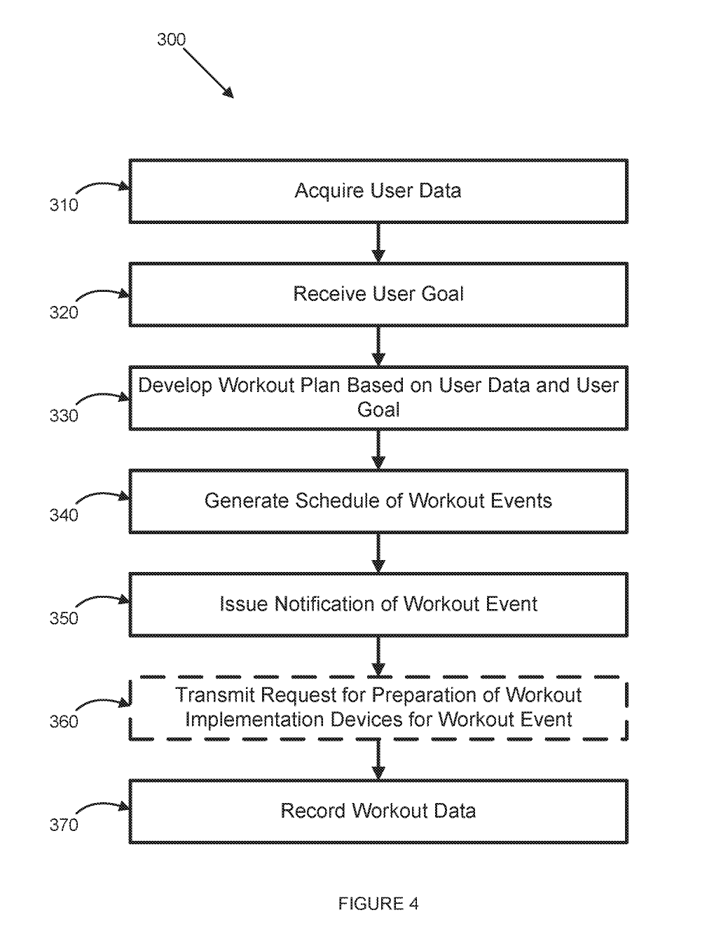

FIG. 4 illustrates an example process 300 of an HBHSD, such as HBHSD 105 (FIG. 1), HBHSD 205 (FIG. 2), or HBHSD 2002 (FIG. 3), implementing a workout plan. The workout plan may be a portion of a health plan. In some examples, the HBHSD may issue a message recommending consulting with a physician for evaluation before engaging in a self guided program for exercise or skills development using the HBHSD. Further, the HBHSD may be configured to provide audio and visual aids to guide the user through process 300.

Step 310 comprises acquiring user data. Acquiring user data may begin by registering one or more users with a HBHSD. User data may be acquired from one or more of a user providing input into user interaction devices 140 (FIG. 1), data collected by data collection devices 135 (FIG. 1), communication devices 125 (FIG. 1) containing information associated with the user, and any of the other shared resources 110 (FIG. 1) and private resources 130 (FIG. 1) that may be communicatively coupled to the HBHSD. The HBHSD may be configured to obtain information from certain sources and may provide instructions to a user for facilitating access to the certain sources by the HBHSD.

The acquired user data may include one or more of a user's age, sex, height, weight, physical dimensions, ethnicity, level of skill or health condition of the user, physical activity, physical response based on physical condition, level of skill of the user in managing a health plan and/or condition, family associated with the user, type of work the user performs, what activities the user's typical work day involves, typical transportation utilized by the user, the user's typical diet, the location of the user, dress or customs of the user that may affect which exercises a user can perform or foods a user may eat, or some combination thereof. Further, the acquired user data may include conditions surrounding the user, such as climate in a geographic area of a user's location, altitude of the user's location, time of year and likely weather associated with the time of year, or any combination thereof. In some examples, the data collection may be limited to what is necessary for development of a health plan. In some examples, all, or a portion, of the information may be acquired through social networking accounts associated with the user.

The acquired user data may further comprise a schedule of the user's planned activities. The schedule may be input by the user or may be acquired from the private resources 130 (FIG. 1), may be acquired from communication devices 125 (FIG. 1) associated with the user, may be acquired from the network systems 115 (FIG. 1), or some combination thereof. For example, the HBHSD may access one or more social networking or email networks to acquire a schedule of the user's planned activities. In an instance where multiple calendars are acquired from the network systems 115 (FIG. 1), the HBHSD may generate a combined calendar of user activities based on the multiple calendars.

In step 320, the HBHSD receives a user goal. Receiving a user goal may comprise one or both of receiving a current state of health of the user and a desired state of health of the user. In some examples, the goal may be non-specific, such as wanting to lose weight, while in other examples, the goal may be specific, such as that the user wants to lose 20 pounds within 3 months from the date the goal is set. Further, the user goal may be to prepare for a specific activity, such as preparation for marathons, walking trails, and basic or advanced training in a wide range of various mental or physical activities.

For example, user data and a corresponding user goal may be that the user is 45 and female, has elementary school age children, works a 35-hour work week and is single. She is a bank teller who is at work from 8:00 am until 4:00 pm. She is a private person, feels self-conscious about her weight, and would not like to draw attention to her efforts to lose 20 pounds. She works long shifts standing or sitting and has two fifteen-minute breaks each day—one in mid-morning, the other mid-afternoon, and one 45-minute lunch break. She takes public transportation both ways to work (bus and a train). She likes coffee, sweets, lunch is usually a hotdog from the corner vendor, and she drinks canned soda twice a day. Dinner is often takeout or a prepared frozen meal from the grocery store. She often cooks on weekends. Example minimum information related to the user that the HBHSD may need to begin a health plan for the goal of losing 20 pounds is that she takes public transportation, eats a lot of take out, and stands or sits for about 7 hours each day she works, which can be 5-6 days a week.

In step 330, the HBHSD may develop a workout plan based on the acquired user data and the user goal. The workout plan may be based on all, or a portion, of the acquired user data and the user goal. The HBHSD may rely on activity and/or scheduling information provided by the user to maximize the desired outcome of the workout plan. In some examples, the workout plan may be based on a physical condition of the user, day-to-day routines of the user, environments that the user is in throughout the day-to-day routines, the user goal, or some combination thereof.

Information regarding descriptions of physical locations of the user may be used to determine which workout activities or skills development activities should be scheduled when the user is at the described location. The descriptions of the physical locations may not include addresses or other specifics regarding the physical location. The workout and/or health recovery plan may include therapy, medication, diet, and/or exercises that can range from the use of certified exercise equipment and/or medical technology in a home or gym to tasks and/or exercises that may be performed in an office or home setting. For example, the HBHSD may consider that the user's work occurs inside of an office cubical versus a personal office, outside, or in a group setting when selecting workout activities or skill development activities that would fit the circumstances and personal preferences of the user.

Further, the development of a workout plan may include determining the best use of a user's time throughout a day. The workout plan may generate recommendations for items to purchase or rent that may enhance the workout plan, the recommendations may include brand names of the items and which items are system compatible exercise equipment. In some examples, the recommendations may include guidance on methods to achieve a user's objectives, the time required to achieve the objectives, a frequency of certain activities to achieve the objectives, or a combination thereof.

Further, the workout plan may schedule group activities that may enhance the workout plan. The group activities may be scheduled with multiple users of a HBHSD, multiple users registered with different HBHSDs, the general public, or any combination thereof.

In step 340, a schedule of workout events is generated. A workout event may comprise one or more activities, including workout activities, skills development activities, and group activities. The workout events may be scheduled around the schedule of the user's planned activities acquired in step 310. For example, the schedule of workout events may include workout events lasting 30 minutes scheduled in the morning and afternoon, at times when the user is available, such as when the user does not have any planned activities scheduled. The schedule of workout events may further include waking 30 minutes earlier to engage in exercise at home before the user's children wake or getting off a bus stop prior to the usual stop to walk a distance.

In step 350, the HBHSD may issue a notification of a pending workout event. The notification may include a time at which the workout event is scheduled, where the workout event may be performed, how long the workout event is scheduled to last, or any combination of these. Further, the notification may be configured to include instructions on how to perform the workout event or may provide a link to the instructions. In some examples, the notification may comprise, or may be accompanied by, an alarm being triggered on a clock, a voice interface being triggered on a clock, a text message being sent to a smart phone, or a combination thereof.

In some examples, the HBHSD may issue multiple notifications at different times, where one or more of the notifications include information that may be used to prepare for the pending workout event. For example, the notifications may include preparation instructions for events occurring the following day, such as what items a user should have with them prior to leaving home on the following day.

Further, in some examples, the notification may comprise a confirmation selection, a reschedule selection, a request alternative activity selection, or any combination thereof, allowing the user to indicate whether the user is starting the workout event or whether the workout event needs to be rescheduled. The schedule of workout events may update accordingly in response to the user's selection.

In some examples, one or both of the schedule of workout events and/or patient recovery plans may include notifications of workout events, tasks, appointments and/or plans that may be transmitted and stored on one or more portable devices, such as communication devices 125 (FIG. 1) and user interaction devices 140 (FIG. 1). The schedule of workout events and/or the notifications may be transmitted to the portable devices on a set schedule, such as daily, weekly, or monthly, in order to help the user stay on track with the health plan. In some examples, an updated schedule of workout events and/or notifications may be transmitted in response to modifications of the schedule of workout events.

In step 360, a request is transmitted to workout implementation devices, such as workout implementation devices 150 (FIG. 1), wherein the workout implementation devices are prepared for operation in response to the request. Preparing the workout implementation devices may comprise one or more of turning on the workout implementation devices, warming up the workout implementation devices, and loading a workout program associated with the corresponding workout event into the workout implementation devices. Further, the workout implementation devices may include building systems around a piece of workout equipment and the building systems may respond to the request, such as turning on lights in the building and/or turning on air conditioning or heating in the building.

In some examples, the workout event may utilize no workout equipment or equipment that is not communicatively coupled to the HBHSD. In this case, step 360 may not occur and may be skipped in process 300.

In step 370, the HBHSD may record data associated with the workout event. The data may be recorded by a plurality of sensors, including proximity sensors, bio-chemical sensors, wearable body sensors, thermal sensors, imaging systems and sensors, sensors mounted or sewn into clothing, or some combination thereof.

The sensors may be configured to continuously monitor a user's vital signs for derivations from expected exercise levels. The HBHSD may access information related to physical exertion or over exertion, data from critical care technologies, observations from care givers, and may identify symptoms that indicate the user needs to stop the workout, the activity and/or take a specific action. Audio and/or text warnings may be issued based on sensor measurements that indicate an unanticipated change in the user's vital signs or indications that the user may be approaching injury. In some examples, the HBHSD may transmit an alert to emergency systems, such as emergency systems 206 (FIG. 2), requesting medical service and/or intervention measures.

In some examples, the recorded data may be transmitted to workout implementation devices associated with the workout event in real-time or substantially real-time. The workout implementation device may then modify the workout event to optimize the benefit of the workout event for the user.

The HBHSD may transmit the recorded data to a local library, such as local library 145 (FIG. 1), for storage and for analysis to update the health plan accordingly. In some examples, the HBHSD may further transmit the recorded data to a third party, such as network systems 115 (FIG. 1) or network systems 210 (FIG. 2). A health professional may be able to analyze the recorded data through a health professional communication system, such as health professional communication systems 255 (FIG. 2).

In some examples, the recorded data may include which activities associated with a workout event were performed by a user and which activities associated with workout event were not performed by a user. Based on the frequency of a user performing an activity or a user choosing not to perform an activity, the HBHSD may modify, or generate, a schedule of workout events to include workout events with activities that a user consistently performs rather than workout events with activities that a user tends to avoid.

In some examples, the HBHSD can inform a discharging hospital, a physician, a therapist, a home care provider and/or a patient of status of recovery plan and/or skills development program. The status of the recovery plan and/or the skills development program may be determined based on which activities were performed by the user, which activities were not performed by the user, the frequency of the user performing the activity, the frequency of the user choosing not to perform the activity, or some combination thereof. The HBHSD may determine the status based on any one of these factors, the goal of the user, and/or the plan (health, workout, recovery, and/or nutrition) associated with the user.

In examples where the workout event comprises a group activity, a portion of the recorded data may be transmitted to a device associated with an instructor and/or a supervisor of the group activity. In this situation, the instructor or supervisor may be able to monitor the vital signs and locations associated with a group of users involved in the group activity to verify that the group activity is being performed correctly and none of the users are having issues.

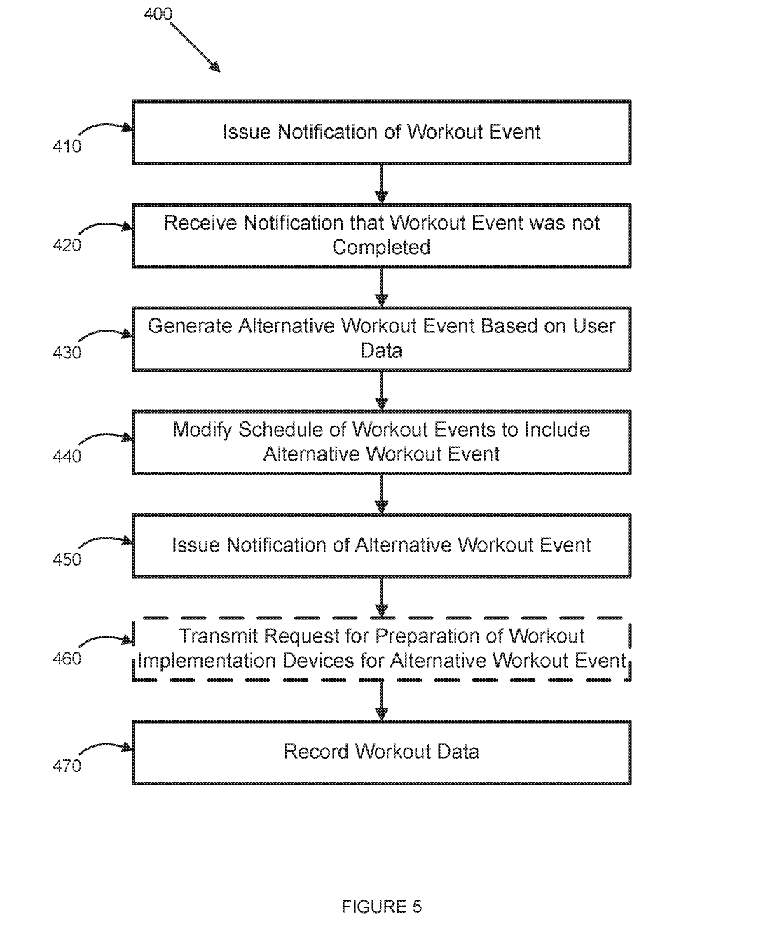

FIG. 5 illustrates an example process 400 of an HBHSD, such as HBHSD 105 (FIG. 1), HBHSD 205 (FIG. 2), or HBHSD 2002 (FIG. 3), modifying a workout plan based on non-completed workout events. In step 410, the HBHSD may issue a notification of a pending workout event. The notification of step 410 may be similar to the notification in step 350 of FIG. 4.

In step 420, the HBHSD may receive notification that a workout event was not completed. The notification may be generated by a user indicating the workout event was not completed, one or more of data collection devices associated with the workout event measuring values that indicate the workout event had not been completed, or workout implementation devices associated with the workout event not being utilized by the user.

In step 430, the HBHSD may generate an alternative workout event to replace the non-completed workout event. Generating the alternative workout event may occur, in at least some aspects, similarly to the developing a workout plan in step 330 of FIG. 4. The alternative workout event may comprise a similar activity to the non-completed workout event or may comprise one or more different activities intended to have similar health benefits as the non-completed workout event. In some examples, an activity selected for the alternative workout event may be selected based on collected data indicating that the user is more likely to complete the activity.

In step 440, the HBHSD may modify the schedule of workout events to include the alternative workout event. The alternative workout event may be added to the schedule during a time that another workout event or user activity is not scheduled. In other examples, the alternative workout event may replace a previously scheduled workout event, with the alternative workout event intended to have greater health benefits than the previously scheduled workout event to compensate for the non-completed workout event.

In step 450, the HBHSD may issue a notification of the pending alternative workout event. The notification of step 450 may be similar to the notification of step 410 or the notification of step 350 of FIG. 4.

In step 460, the HBHSD may transmit a request for preparation of workout implementation devices associated with the alternative workout event. Step 460 may be similar, at least in some aspects, to step 360 of FIG. 4.

In step 470, the HBHSD may receive and record workout data provided by data collection devices associated with the alternative workout event. Step 470 may be similar, at least in some aspects, to step 370 of FIG. 4.

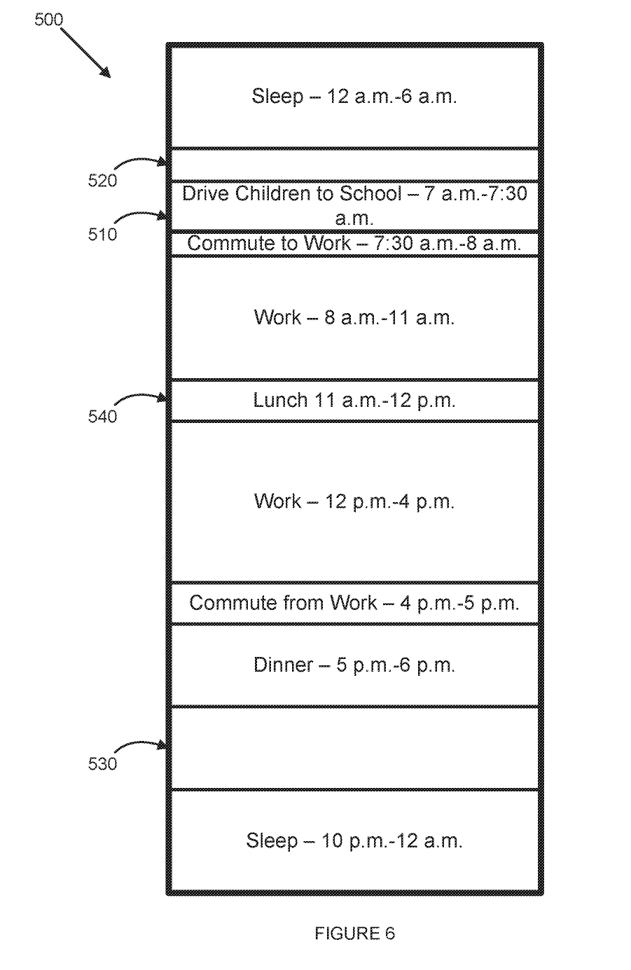

FIG. 6 illustrates an example schedule 500 acquired by an HBHSD, such as HBHSD 105 (FIG. 1), HBHSD 205 (FIG. 2), or HBHSD 2002 (FIG. 3). The schedule may be acquired similarly to the schedule in step 310 of FIG. 4. While the schedule illustrated is for a 24-hour period, it is to be understood that in other examples the schedule may be for different time lengths.

The schedule may include a plurality of a user's planned activities, such as driving the children to school 510. The HBHSD may be configured to identify time periods during the schedule where the user is available (has no planned activities scheduled), such as free time periods 520 and 530. The HBHSD may schedule workout events during these free time periods 520 and 530. This scheduling of the workout events may be utilized by the generating schedule step recited in step 340 (FIG. 4), the modifying schedule step recited in step 440 (FIG. 5), or both.

In some examples, the HBHSD may further be configured to identify one or more of the planned activities in the schedule that would be likely to have extra time where a workout event may be completed. For example, the HBHSD may recognize that lunch 540 does not take an hour to eat and may schedule a workout event during a portion of the time scheduled for lunch 540.

The HBHSD may further be able to recommend modifications to the schedule as part of a health plan. For example, rather than driving the children to school 510, the HBHSD may recommend walking the children to school and leaving the house before 7 am to provide time for the walk. Other examples of recommendations that may be made by the HBHSD include recommending that the user wake up 10 minutes earlier to take a longer route to a bus stop, arriving at work 5 minutes earlier to park further from the building to walk 3 minutes longer, and taking stairs rather than an elevator at an end of a work day. The recommendations may be similar, at least in some aspects, to the notification issued in step 350 of FIG. 4 or notifications issued in steps 410 and 450 of FIG. 5.

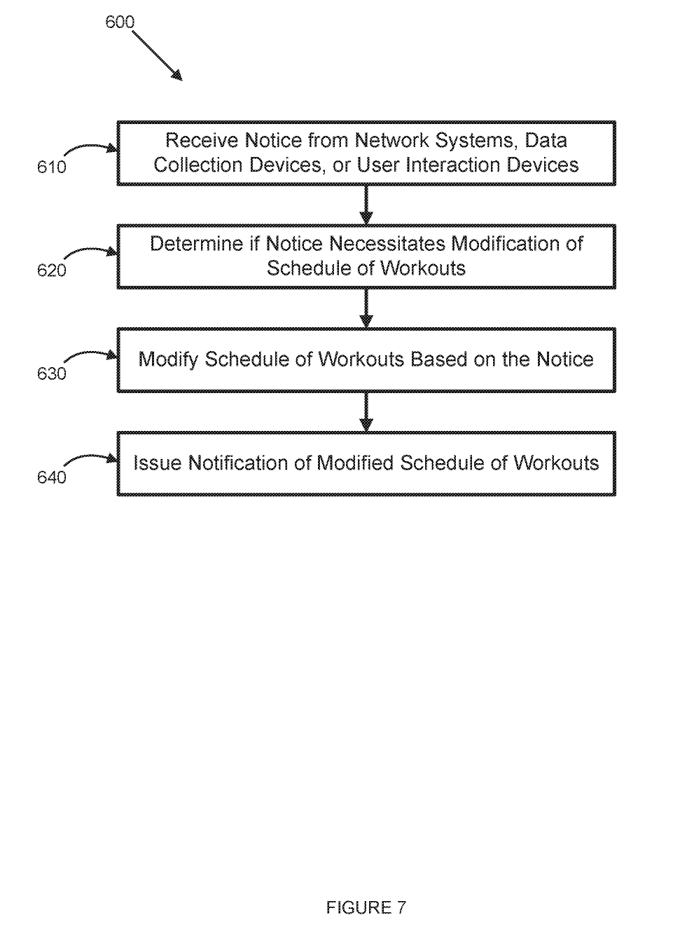

FIG. 7 illustrates an example process 600 of an HBHSD modifying a workout plan based on acquired data. In step 610, the HBHSD may receive one or more notices from network systems (such as network systems 115 of FIG. 1, or network systems 210 of FIG. 2), data collection devices (such as data collection devices 135 of FIG. 1), user interaction devices (such as user interaction devices 140 of FIG. 1), communication devices (such as communication devices 125 of FIG. 1), and/or workout implementation devices (such as workout implementation devices 150 of FIG. 1).

The one or more notices may include data indicating a change in a user's schedule of planned activities, that the workout implementation devices are not available during a scheduled workout event time, a change in availability of a resource, or other similar occurrences. For example, a notice may be received from the network systems indicating that a bus that a user rides to work is running 10 minutes late. In some examples, information about the user, such as that the user is losing weight too quickly or the user is not enjoying certain exercises, may generate a notice to modify the workout plan.

Notices may also be based on environmental events that could affect completion of a workout event. For example, if local weather is poor for a day when a workout event is scheduled to occur outside a notice could be generated. In response to the notice, the HBHSD may search for alternative activities that may be performed indoors, such as volunteering to take items to other departments or taking the stairs instead of the elevators.

In some examples, the HBHSD may be configured to poll shared resources, such as shared resources 110 (FIG. 1), and/or private resources, such as private resources 130 (FIG. 1), for any changes that may affect a workout event at a specified time prior to the event's scheduled time. For example, the HBHSD may poll a weather forecast system, such as weather forecast system 225 (FIG. 2) an hour prior to the scheduled start time of an outdoor workout event.

In step 620, the HBHSD may determine whether the data from the notification necessitates modification of a schedule of workout events. Determining whether the data necessitates modification may comprise updating the user's schedule of planned activities to compensate for the change and then comparing the updated schedule of planned activities with the schedule of workout events to determine if there exists a conflict between the schedules.

In step 630, in response to determining that the notification necessitates modification of a schedule of workout events, the HBHSD may modify the schedule of workout events accordingly. The step of modifying the schedule may occur similarly, at least in some aspects, to the modification in step 440 of FIG. 5. Modifying the schedule of workout events may further comprise delaying a scheduled workout event by a period of time so it does not overlap with a user's schedule of planned activities. For example, in response to the bus running 10 minutes late, the HBHSD may modify a planned walk occurring after the bus delivers the user to work to begin 10 minutes later.

In step 640, the HBHSD may issue a notification of the modified schedule of workout events. The notification may be similar, at least in some aspects, to the notification in step 350 of FIG. 4, or the notifications in steps 420 and 450 of FIG. 5. The notification may include an indication of any planned activities and/or workout events that have been modified, such as by highlighting the modified activities and/or events.

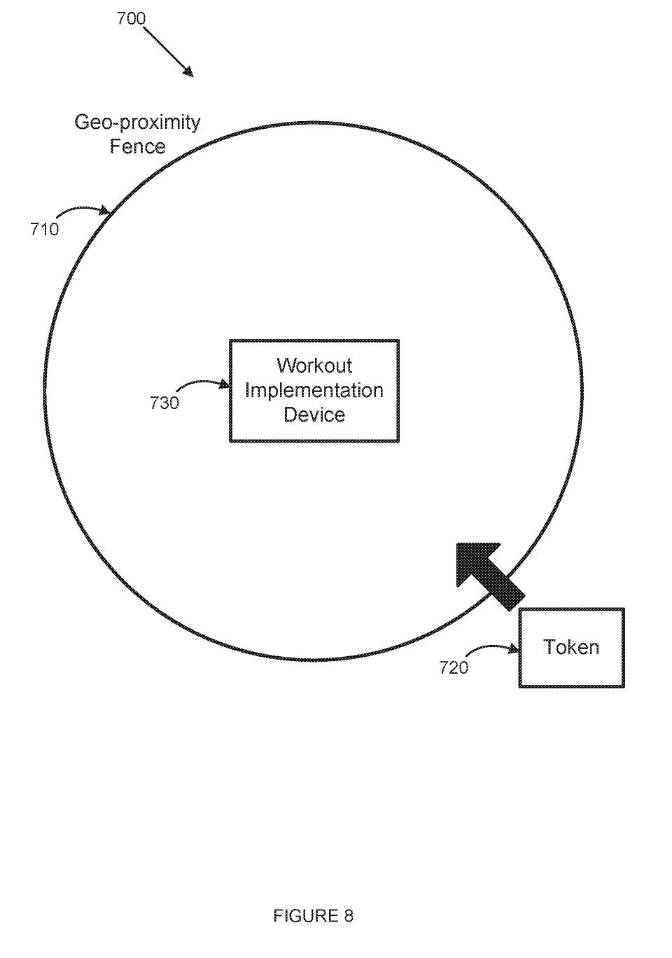

FIG. 8 illustrates an example implementation device preparation system 700 with geo-proximity coral 710 determining presence of a token 720. Geo-proximity coral 710 and token 720 may be similar to geo-proximity fences and tokens described in U.S. patent application Ser. No. 14/648,612, published as U.S. Pat. Pub. No. US 2015-0310173 A1, which is herein incorporated by reference.

The implementation device preparation system 700 may comprise one or more workout implementation devices 730. The geo-proximity coral 710 may encompass the one or more workout implementation devices 730. The implementation device preparation system 700 may be configured to prepare the workout implementation devices 730 for a user in response to the token 720 associated with a user entering an area encompassed by the geo-proximity coral 710. The preparation of the workout implementation devices 730 may be similar, at least in some aspects, to the preparation described in step 360 of FIG. 4.

The implementation device preparation system 700 may be configured to operate with multiple different tokens, such as token 720. The multiple different tokens may be registered with one or more of the HBHSDs, such as HBHSD 105 (FIG. 1), HBHSD 205 (FIG. 2), or HBHSD 2002 (FIG. 3), and may be associated with multiple different users. In response to sensing a certain token entering the geo-proximity coral 710, the implementation device preparation system 700 may determine which user is associated with the certain token and prepare the workout implementation devices 730 according to a workout event associated with the user.

In some examples, an HBHSD may be configured to track a location of the token 720, thereby providing the HBHSD with a location of a user associated with the token 720. By performing the tracking, the HBHSD may be able to determine where the user is located and modify a health plan or a workout event associated with the user accordingly.

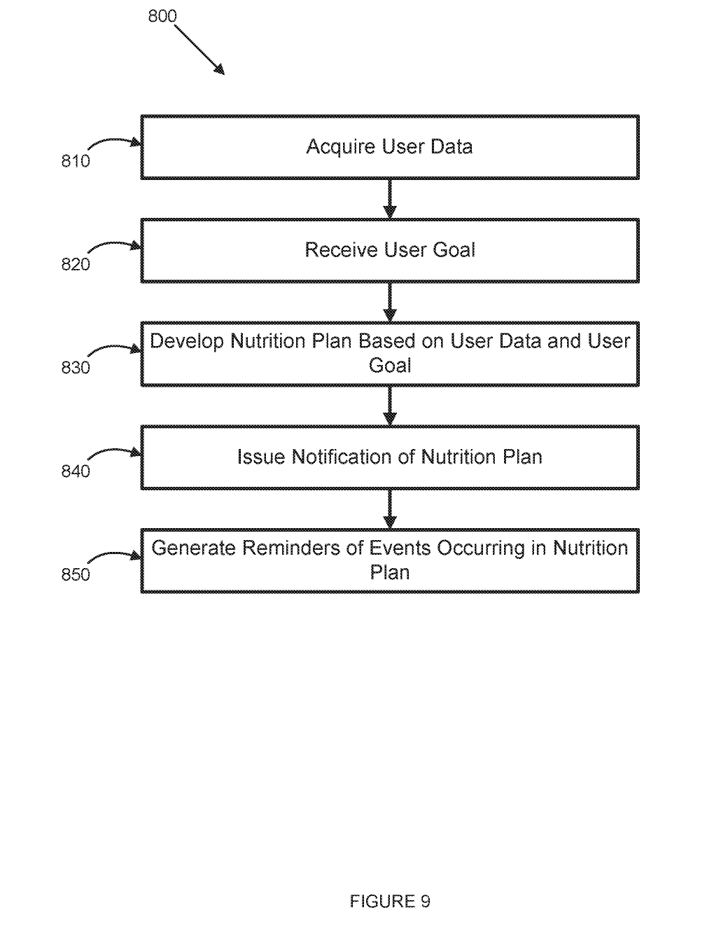

FIG. 9 illustrates an example process 800 of an HBHSD, such as HBHSD 105 (FIG. 1), HBHSD 205 (FIG. 2), HBHSD 2002 (FIG. 3), implementing a nutrition plan. A health plan generated for a user may comprise a nutrition plan, a workout plan, or both. In step 810, the HBHSD may acquire user data, similar to the user data gather by step 310 of FIG. 4. Further, the acquired user data may comprise caloric intake for the user over a period of time, the user's preferences in nutrition, nutrition proximate or available to the user, or any combination thereof.

In step 820, the HBHSD may receive a user goal. The step of receiving a user goal may be similar, at least in some aspects, to receiving a user goal described in step 320 of FIG. 4. In some examples, the user goal may comprise limiting sodium intake, limiting caffeine intake, limiting fat intake, increasing protein intake, or similar objectives.

In step 830, the HBHSD may develop a nutrition plan based on the user data and the user goal. Developing a nutrition plan may be similar, at least in some aspects, to developing a workout plan as described in step 330 of FIG. 4, with the exception that nutrition events associated with the user are being selected rather than exercises, workout activities, or workout events. The HBHSD may generate a schedule of nutrition events for the user.

The nutrition plan may be configured to assist with incremental changes in diet to meet objectives that focus on optimizing enjoyment of the user. For example, if the user prefers salty, crunchy, spicy or sweet snacks, the HBHSD may select nutrition events that include dried fruits, vegetables, or nuts, as well as providing information on traditional sweeteners and recommended equivalent replacements. In some examples comprising both a workout plan and a nutrition plan, the HBHSD may be configured to suggest snacks breaks and meals to compensate for lost exercise time while making sure that a user receives proper food and fluid throughout the day.

Further, the nutrition plan may include recipes, including detailed step-by-step instructions, associated with the nutrition events and cooking events, where food or liquids are prepared for the nutrition events. For example, the HBHSD may schedule cooking events during a week for preparing foods that can be consumed for lunch during the week.

In step 840, the HBHSD may issue a notification of a nutrition plan. The notification may be transmitted to one or both of user interaction devices, such as user interaction devices 140 (FIG. 1), and communication devices, such as communication devices 125 (FIG. 1), associated with the user. The notification may indicate that a nutrition plan has been developed and may provide the user interaction devices and the communication devices with the schedule of nutrition events. Further, the notification may include a list of foods, liquids, ingredients, or combinations thereof, which the user should obtain to follow the nutrition plan.

In some examples, the notification may include an indication of benefits that the nutrition plan provides. For example, a nutrition plan under these circumstances may recommend a switch from canned soda to water. The notification may provide a benefit indication or an inducement for switching to water, such as an amount of money saved by drinking water rather than canned soda.

Examples of other benefit indications or inducements may include: switching from breads to flat breads or crackers to save on calories, increasing consumption of vegetables to fill out a diet that is reducing caloric intake, limiting an amount of salad dressing consumed and offering recipes on how to make salad dressings that may reduce the cost of meals and reinforce improved health options, drinking eight-8 oz glasses of water a day while engaging in physical exercise to maintain proper waste disposal that the body must go through when burning calories, reducing over eating or the retaining calories due to inconsistent eating by staying on a routine for food consumption.

In step 850, the HBHSD may generate and transmit reminders of events occurring in the nutrition plan. Reminders may be generated for one or both of the nutrition events and the cooking events.

For nutrition events, the reminder may include types of nutrition to ingest, an amount of each type of nutrition to ingest, a time to ingest the nutrition, or any combination thereof. Further, the reminder may include a way for the user to indicate that the nutrition event has been completed or needs to be rescheduled.

For cooking events, the reminder may include an indication of what nutrition is to be prepared, a recipe for preparing the nutrition, a time scheduled for the cooking event, or any combination thereof.

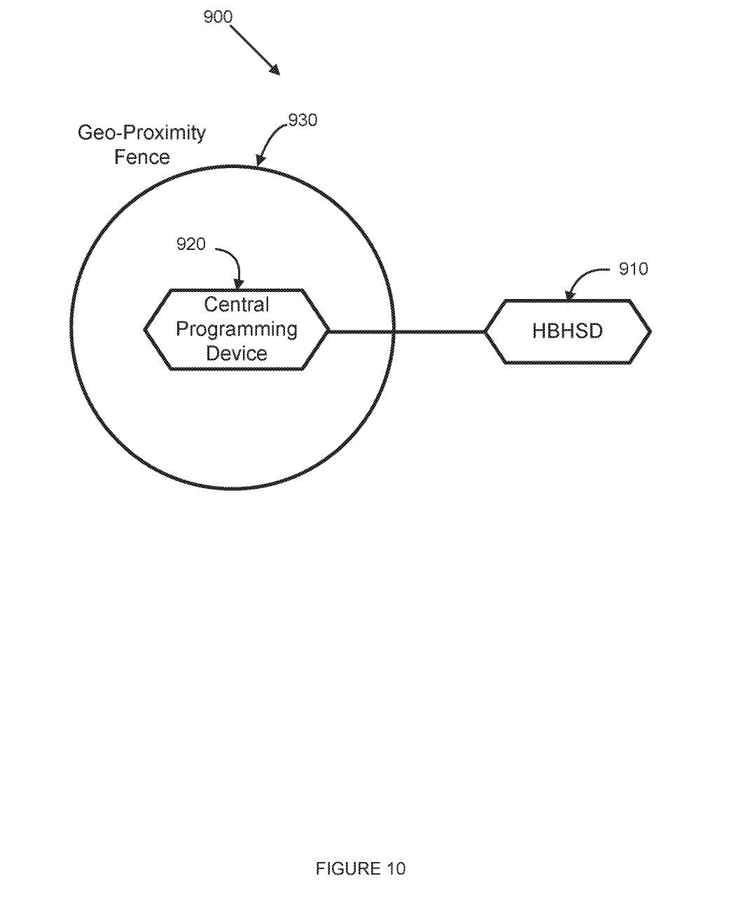

FIG. 10 illustrates an example network 900 between a HBHSD 910 and a central programming device 920. Central programming device 920 may be similar to central programming devices disclosed in U.S. patent application Ser. No. 14/648,612, which is herein incorporated by reference (‘App. No. '612’). The HBHSD 910 may include one or more of the features of HBHSD 105 (FIG. 1), HBHSD 205 (FIG. 2), or HBHSD 2002 (FIG. 3). The HBHSD 910 may be communicatively coupled to the central programming device 920 and may transmit data and commands to the central programming device 920, receive data and commands from the central programming device 920, or both.

The central programming device 920 may include a geo-proximity coral 930 similar to the geo-proximity corals disclosed in App. No. '612. The central programming device may be configured to track items as the items enter the geo-proximity coral 930, exit the geo-proximity coral 930, are located within the geo-proximity coral 930, or any combination thereof. The central programming device 920 may be configured to maintain an inventory of items and generate an alert when an inventory of an item is lower than a set value. The alert may be displayed on the central programming device 920, the HBHSD 910, devices communicatively coupled to the central programming device 920, devices communicatively coupled to the HBHSD 910, or any combination thereof. The inventory of items may be communicated to the HBHSD 910, which may base a selection of nutrition events on the inventory of items, generate a notice that additional items are required for a health plan, or any combination thereof.

The central programming device 920 may be configured to access a directory of barcodes and may be able to identify an item based on the barcodes. Further, the central programming device 920 may be able to generate tags to be placed on items that allows the central programming device 920 to identify the items. The central programming device 920 may be configured to track the items using the barcodes, the tags, or both, and may be able to update the inventory of items as items having the barcodes, tags, or both are moved into or out of the geo-proximity coral.

In some examples, an example network may comprise a HBHSD 910, where the HBHSD 910 comprise all or a portion of the features of the central programming device 920, such as a geo-proximity coral and the ability to track items. In these examples, a central programming device 920 may not be included in the system.

Having described and illustrated a home based health and skills development programming system (HBHSD) through examples, it should be apparent that the HBHSD may be modified in arrangement and detail without departing from such principles. It should be understood that the scope of this disclosure is not limited to the specific examples provided within this disclosure, but includes all modifications and variations coming within the spirit and scope of claims that may be issued from this application.

In some examples, a system, comprises: a home base device configured to: register a user; receive a user goal; acquire information relating to the user, wherein the information includes a schedule of the user's planned activities; generate a health plan schedule based on the goal and the information, wherein the health plan schedule comprises a plurality of health events that can encompass a range of activity that may include resting, sleeping, walking, exercising, therapy sessions, and/or other scheduled activity to complement the user's planned or routine activities; and initiate a reminder for the user to perform one of the plurality of health events.

In some examples, the home base device is further configured to: receive information on the user physical dimensions (manual or automated); enroll, de-enroll (manual or automated) and track items linked to the home base device wile within range of the home base device; access data on nutrition of foods available at local markets; access a directory of barcodes and associated food products by manufacturers; access weather and traffic conditions to support more accurate calculations for the purpose of honing the health plan to a precession that maximizes the users time and benefit of using the system; enroll food items in system by converting barcodes into machine readable formats encode the digitized barcode information to blank radio-frequency tags that can be applied to the product packaging to record food items in home and de-role items on the system (automated or manual) when packaging is discarded; and confirm weather forecast for a hour prior to the set alarm, if clear and within acceptable conditions—initiate a reminder to a bed room alarm clock and a text message to a smart phone or a voice interface on the clock that is triggered when ambient light in the room changes to relay a message that a scheduled activity will take place in the morning and what the activity is so that the user is prepared. The user may decline the activity, ask for an alternative, or remain silent to perform one of the plurality of health events for example awake 30 minutes earlier—to walk twice around the block on the way to a bus top.

In some examples, the home base device is further configured to identify locations of the user associated with the different times, and wherein the plurality of health events comprise exercise activities selected based on the locations of the user.

In some examples, the system further comprises a token that tracks the user's performed activities, and wherein the home base device is further configured to: receive a record of the user's performed activities from the token; and modify the health plan schedule based on the record of the user's performed activities.

In some examples, the home base device is further configured to: receive an indication of public transportation utilized by the user; acquire current projections and route schedules associated with the public transportation utilized by the user; identify deviations between the current projections and the route schedules; and modify the health plan schedule based on the deviations.

In some examples, the request includes instructions of how to perform the one of the plurality of health events.

In some examples, the home base device is further configured to: identify exercise facilities within a proximity of the user; and modify the health plan to utilize the exercise facilities.

In some examples, the plurality of health events comprises meal breaks including indications of items to be consumed by the user.

In some examples, the indications of items to be consumed by the user includes recipes for preparing the items.

In some examples, the home base device is further configured to note the frequency of certain activities being performed, and those that are avoided to adjust the selection to suit preferences through learning.

In some examples, the home base device is linkable with applications embedded in materials designed for sports or activities.

In some examples, the home base device is further configured to receive programmable activities to aid in improvement of defined skills or activities the user identifies and utilize the programmable activities in a health plan.

In some examples, the home base device is further configured to access and load details from skills and activities libraries.

In some examples, the home base device is further configured to allow a user to program applications or devices embedded in apparel for select skills development and improvement.

In some examples, a computer readable medium having instructions stored thereon, wherein, in response to executing the stored instructions, comprises a processor is configured to perform operations comprising: registering a user; receiving a goal associated with the user; acquiring scheduling information associated with the user, wherein the scheduling information includes a plurality of planned activities associated with the user;

In some examples, the operations further comprise generating a health plan for the user based on the goal and the scheduling information, wherein the health plan includes a plurality of exercise events, each of the plurality of the exercise events being associated with a time and a day when none of the plurality of planned activities is scheduled.

In some examples, operations further comprise initiating a reminder for the user to perform an exercise event from the plurality of the exercise events when the time and day associated with the exercise event occurs.

In some examples, the operations further comprise, upon request, accessing audio book library, music libraries, work related information, lectures or other information that the user may want to digest as they work on a particular aspect of a health plan.

What is claimed is:

1. A system, comprising:
a home base device configured to:
register a user;
receive a user goal;
acquire information relating to the user, wherein the information includes a schedule of planned activities of the user;
generate a health plan schedule based on the user goal and the information, wherein the health plan schedule comprises a plurality of health events scheduled to complement the planned activities of the user; and
initiate a reminder for the user to perform one of the plurality of health events in accordance with the health plan schedule.

2. The system of claim 1, wherein the home base device is further configured to:
receive physical dimensions of a range of the home base device;
enroll one or more items linked to the home base device in response to entry of the items into the range of the home base device; and
track the items while within the range of the home base device.

3. The system of claim 2, wherein the home base device is further configured to de-enroll the items in response to exit of the items from the range of the home base device.

4. The system of claim 2, wherein the items include food products and wherein the home base device is further configured to:
access a directory of barcodes associated with the food products;
identify barcodes corresponding to the food products from the directory of barcodes; and
detect entry of the barcodes corresponding to the food products into the range of the home base device, wherein the food products are enrolled in response to the detection of the entry of the barcodes.

5. The system of claim 1, wherein the home base device is further configured to identify locations of the user associated with the different times, and wherein the plurality of health events comprise exercise activities selected based on the locations of the user.

6. The system of claim 1, further comprising a token that tracks performed activities of the user, and wherein the home base device is further configured to:
receive a record of the performed activities from the token; and
modify the health plan schedule based on the record of the performed activities.

7. The system of claim 1, wherein the home base device is further configured to:
receive an indication of public transportation utilized by the user;
acquire current projections and route schedules associated with the public transportation;
identify deviations between the current projections and the route schedules; and
modify the health plan schedule based on the deviations.

8. The system of claim 1, wherein the reminder includes instructions of how to perform the one of the plurality of health events.

9. The system of claim 1, wherein the home base device is further configured to:
identify one or more exercise facilities within a proximity of the user; and
modify the health plan schedule to utilize the exercise facilities.

10. The system of claim 1, wherein the one or the plurality of health events includes a nutrition break, and wherein the reminder includes an indication of one or more items to be consumed by the user during the nutrition break.

11. The system of claim 10, wherein the indication of the items to be consumed by the user includes at least one recipe for preparing at least one of the items.

12. The system of claim 1, wherein the home base device is further configured to:
detect a first group of activities being performed by the user and a second group of activities being avoided by the user; and
adjust the health plan schedule based on detection of the first group of activities being performed and the second group of activities being avoided.

13. The system of claim 1, wherein the home base device is further configured to:
link with one or more activity-specific collection devices associated with the one of the plurality of health events;
obtain data from the activity-specific collection devices collected during user performance of the one of the plurality of health events; and
update the health plan schedule based on the data obtained from the activity-specific collection devices.

14. The system of claim 1, wherein the home base device is further configured to obtain instructions on how to perform a defined skill or activity associated with the one of the plurality of health events, wherein the reminder displays the instructions.

15. The system of claim 14, wherein the home base device is further configured to obtain the instructions from a global library communicatively coupled to the home base device.

16. The system of claim 1, further comprising one or more devices embedded in apparel, wherein the home base device is further configured to cause the one or more devices in the apparel to provide non-verbal sensory feedback associated with the one of the plurality of health events during user performance of the one of the plurality of health events.

17. The system of claim 1, wherein the home base device is further configured to receive instructions from a care-related service provider, wherein the generation of the health plan schedule is further based on the instructions from the care-related service provider.

18. A computer readable medium having instructions stored thereon, wherein, in response to execution of the stored instructions, the stored instructions cause a processor to perform operations comprising:
registering a user;
receiving a goal associated with the user;
acquiring scheduling information associated with the user; and
generating a health plan schedule that includes a plurality of health activities for performance by the user based on the goal associated with the user and the scheduling information associated with the user.

19. The computer readable medium of claim 18, wherein generating the health plan schedule includes scheduling the plurality of health activities for times when the scheduling information indicates that the user is available.

20. The computer readable medium of claim 18, wherein the operations further comprise initiating a reminder for the user to perform an exercise event from the plurality of health activities based on a scheduled time to perform the exercise event included in the health plan schedule.

21. The computer readable medium of claim 18, the operations further comprise:
obtaining video instructions associated with one or more health activities from the plurality of health activities; and
displaying the video instructions associated with the health activities in accordance with the health plan schedule.

22. A home-based health skills development programming system, comprising:
a memory device; and
a processing device configured to:
register a user;
access encrypted data on private resources associated with the user, wherein the private resources limit access to the user;
retrieve a schedule of planned events of the user from the encrypted data on the private resources;
retrieve a list of activities that the user consistently performs from the encrypted data on the private resources;
generate a schedule of workout events for the user, wherein the workout events include activities selected from the list of activities that the user consistently performs, and wherein the schedule of workout events is scheduled around the schedule of planned events; and
initiate a reminder to perform one of the workout events from the schedule of workout events in response to determining a time associated with the one of the workout events is approaching.
